(19) United States
(12) Patent Application Publication
(10) Pub. No.: US 2007/0181721 A1
(43) Pub. Date: Aug. 9, 2007

(54) Devices and methods for shredding media into different sizes

(76) Inventor: Joseph Y. Ko, Laguna Niguel, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/594,708

(22) Filed: Nov. 8, 2006

Related U.S. Application Data
(60) Provisional application No. 60/734,930, filed on Nov. 9, 2005.

(51) Int. Cl. B02C 18/16

(52) U.S. Cl. 241/100; 241/236

(57) ABSTRACT

Shredding devices and methods capable of cutting material, such as one or more pieces of media, into different-sized portions. In certain examples, a cross-cut shredding device comprises multiple blades, each having a plurality of blade tips disposed around the periphery of the blades. The blades tips may be unequally spaced to produce shredded pieces having varying lengths. In other examples, a cross-cut or strip-cut shredding device may comprise blades having varying spaces therebetween, which results in shredded pieces with varying widths. Varying the blade tip spacing, the blade width, and/or the blade spacing is advantageously used to produce shredded media of different sizes. Certain shredding devices are configured to produce smaller shredded pieces toward a middle portion of the material to increase the recombination time of shredded material.

### RELATED APPLICATION

This application claims the benefit of priority under 35 U.S.C. §119(e) of U.S. Provisional Application No. 60/734,930, filed on Nov. 9, 2005, and entitled “DEVICES AND METHODS FOR SHREDDING MATERIAL INTO DIFFERENT SIZES,” the entirety of which is incorporated herein by reference and is to be considered a part of this specification.

### BACKGROUND OF THE INVENTION

1. Field of the Invention

Embodiments of the invention relate generally to shredding machines, and, in particular, to devices and methods for shredding material into pieces of different sizes.

2. Description of the Related Art

Shredding devices are commonly used to prevent dissemination of the information on paper, compact discs, magnetically striped cards or other media or material. Many traditional strip-cut shredders cut material inserted therein into strips of uniform length and width. Since such strip-cut shredders do not typically shred material parallel to the direction of insertion, the length of the shredded material is generally unchanged after shredding. For example, material with an original width of 8.5 inches and an original length of 11 inches may be shredded into several 11-inch long pieces each having substantially the same width.

A major drawback of traditional strip-cut shredding devices is the ease with which uniformly-sized shredded pieces can be recombined to ascertain information contained on the material. In particular, an individual generally needs only to appropriately arrange the strips side-by-side to recreate the original material. Given the potential value of confidential information in certain circumstances, material shredded into pieces of uniform width provide little deterrent to those who wish to recombine the shredded pieces and disseminate the confidential information.

To address this drawback of easily recombining shredded material for dissemination of confidential information, some shredder manufacturers have designed shredding devices that perform a cross-cut method. Such cross-cut shredders cut material into portions having a uniform width and a uniform length, wherein both the length and the width of the shredded portions are less than the original length and width of the material. For example, a standard letter-sized paper may be cut into strips of approximately four millimeters wide by fifty millimeters long. Although such cross-cut shredders may increase the recombination time of the shredded media, because the shredded pieces are all still generally the same shape and size, the increase in the recombination time is oftentimes not substantial.

### SUMMARY OF THE INVENTION

In view of the foregoing drawbacks, embodiments of the invention include a shredding device that is capable of further increasing the recombination time of shredded media. In particular, embodiments of the invention include methods and devices for shredding material into portions of different sizes.

In certain embodiments, a shredding device is capable of shredding material into portions with a substantially uniform width and differing lengths. For example, a cross-cut shredding device is disclosed comprising a first roller, a second roller, a first set of blades arranged on the first roller, and a second set of blades arranged on the second roller. A first blade of the first set of blades and a second blade of the second set of blades each includes a plurality of blade tips that have unequal spacings therebetween. The first and second blades both cut a material passing through the shredder into portions of different lengths, wherein the lengths of the cut portions correspond to the lengths of the unequal spacings between the blade tips.

In certain embodiments, a shredding device is capable of shredding material, such as one or more pieces of media, into portions of different widths and having a length approximately equal to the length of the original material. For example, a strip-cut shredding device is disclosed having a first roller comprising a first set of blades and a second roller comprising a second set of blades, wherein at least one blade of the first set of blades has a width different than at least one blade of the second set of blades. As material passes through the strip-cut shredding device, the portions of the material cut by the wider blades have a larger width than portions of the material cut by the narrower blades.

In certain embodiments, a shredding device is capable of shredding material into pieces with a non-uniform width and a uniform length less than the length of the original material. For example, a cross-cut shredding device is disclosed comprising a first roller, a second roller, a first set of blades arranged on the first roller, and a second set of blades arranged on the second roller. A first blade of the first set of blades and a second blade of the second set of blades each includes a plurality of blade tips that have substantially equal spacings therebetween. The first and second blades both cut a material passing through the shredder into portions of the same, or substantially the same, length. Furthermore, the first blade comprises a width that is different than the width of the second blade such that the portions of the material cut by the first blade are wider than the portions of the material cut by the second blade.

In certain embodiments, a shredding device is capable of shredding material into pieces having different widths and different lengths. For example, a cross-cut shredding device is disclosed comprising a first roller, a second roller, a first set of blades arranged on the first roller, and a second set of blades arranged on the second roller. A first blade of the first set of blades and a second blade of the second set of blades each includes a plurality of blade tips that have unequal spacings therebetween. The first and second blades both cut a material passing through the shredder into portions of different lengths, wherein the various lengths of the cut portions correspond to the lengths of the unequal spacings between the blade tips. Furthermore, the first blade comprises a width that is different than the width of the second blade such that the portions of the material cut by the first blade are wider than the portions of the material cut by the second blade.

In certain embodiments of the invention, a shredder blade is disclosed comprising a substantially disc-shaped body having an aperture therethrough for receiving a shredder roller. The shredder blade further comprises a plurality of blade tips disposed around a circumference of the body such that the spacings between the plurality of blade tips are non-uniform. For instance, the shredder blade may include three blade tips wherein a first blade tip is spaced 80 degrees from a second blade tip and 160 degrees from a third blade tip.

In certain embodiments, a consumer-sized shredding device is disclosed for cutting media into different-sized pieces. The shredding device includes a first rotatable member configured to rotate about a first axis and a second rotatable member configured to rotate about a second axis substantially parallel to the first axis. The shredding device further includes a first plurality of blades disposed along the first rotatable member and a second plurality of blades disposed along the second rotatable member, each of the first and second plurality of blades configured to cut a piece of media passing between the first and second rotatable members during rotation of the first and second rotatable members. The second plurality of blades further comprises a first blade, a second blade adjacent the first blade and separated from the first blade along the second axis by a first spacing, and a third blade adjacent the second blade and separated from the second blade along the second axis by a second spacing larger than the first spacing. In certain further embodiments, at least one of the blades of the consumer-sized shredding device comprises at least two blade tips non-uniformly disposed around a periphery of the blade.

In certain embodiments, a household shredding device is disclosed for cutting media into different-sized portions. The household shredding device comprises: a first rotatable member having a distal end, a proximal end and a middle portion therebetween, the first rotatable member configured to rotate about a first axis; and a second rotatable member having a distal end, a proximal end and a middle portion therebetween, the second rotatable member configured to rotate about a second axis substantially parallel to the first axis. The household shredding device further comprises a plurality of blades disposed along the first and second rotatable members, the plurality of blades configured to shred a piece of media passing between the first and second rotatable members during rotation of the first and second rotatable members, wherein a first portion of the plurality of blades is positioned with a first density along the middle portions of the first and second rotatable portions, and wherein a second portion of the plurality of blades is positioned with a second density near the distal and proximal ends of the first and second rotatable portions, the first density being different than the second density.

In certain embodiments, a method is disclosed for shredding media into portions of different sizes. The method includes receiving a piece of media through a feed opening of a consumer-sized shredding device with a first rotatable member and a second rotatable member each having a plurality of blades attached thereto. The method further includes rotating the first and second rotatable members such that the plurality of blades engages the piece of media along a shredding axis as the piece of media passes between the first rotatable member and the second rotatable member. The method also includes cutting a first portion of the piece of media at a first location along the shredding axis to produce shredded media having a first set of sizes and cutting a second portion of the piece of media at a second location along the shredding axis to produce shredded media having a second set of sizes different from the first set of sizes.

In certain embodiments, a consumer-sized shredding device is disclosed comprising means for accepting a piece of media inserted into the shredding device and means for cutting the piece of media into first shredded portions having a first set of sizes. The consumer-sized shredding device further includes means for cutting the piece of media into second shredded portions having a second set of sizes that differs from the first set of sizes.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1A illustrates a cross-sectional view of three blades usable with a strip-cut shredder according to certain embodiments of the invention.

FIG. 1B illustrates a perspective view of an exemplary embodiment of a strip-cut shredder blade.

FIG. 1C illustrates a partial perspective view of an exemplary embodiment of a strip-cut shredding mechanism usable with the blades of FIG. 1A.

FIG. 1D illustrates a cross-sectional view of exemplary embodiments of spacers usable with the strip-cut shredding mechanism illustrated in FIG. 1C.

FIG. 2A illustrates a side cross-sectional view of a blade usable with a cross-cut shredder according to certain embodiments of the invention.

FIG. 2B illustrates a partial perspective view of an exemplary embodiment of a cross-cut shredding mechanism.

FIG. 3 illustrates a partial perspective view of another embodiment of a cross-cut shredding mechanism using blades of different widths.

FIG. 4A illustrates a cross-sectional view of three blades usable with a strip-cut shredder according to certain embodiments of the invention.

FIG. 4B illustrates a partial perspective view of another exemplary embodiment of a strip-cut shredding mechanism.

FIG. 5 illustrates a perspective view of a consumer-sized shredding device according to certain embodiments of the invention.

### DETAILED DESCRIPTION OF THE PREFERRED EMBODIMENTS

The features of embodiments of shredding devices and methods will now be described with reference to the drawings summarized above. The drawings, associated descriptions, and specific implementations are provided to illustrate embodiments of the invention and not to limit the scope of the disclosure.

The term “width” as used herein with respect to shredding methods and devices is a broad term and is used in its ordinary sense and is used without limitation to describe a distance along, or substantially parallel to, a shredding axis, such as a distance along the rotational axis of one or more shredding rollers. For instance, the width of a material to be shredded corresponds to the dimension of the material in a direction substantially perpendicular to the direction of insertion of the material into a shredding device.

The term “spacing” as used herein with respect to shredding methods and devices is a broad term and is used in its ordinary sense and is used without limitation to describe a distance along, or substantially parallel to, a rotatable member between blades mounted on the rotatable member. In certain embodiments, “spacing” refers to the distance between adjacent blades on a single rotatable member. In other embodiments, the term “spacing” may refer to the distance between non-adjacent blades on a single rotatable member, adjacent blades on different rotatable members, and/or non-adjacent blades on different rotatable members.

The term “length” as used herein with respect to shredding methods and devices is a broad term and is used in its ordinary sense and is used without limitation to describe a dimension or distance substantially orthogonal to a corresponding width. For instance, a length of a material to be shredded corresponds to the dimension of the material in a direction substantially parallel to the direction of insertion of the material into a shredding device (e.g., a direction substantially perpendicular to a rotational axis of one or more shredding rollers).

The term “strip cut” as used herein is a broad term and is used in its ordinary sense and is used without limitation to describe apparatus, devices, systems, and the like, that cut material into multiple pieces of substantially equal width and having a length substantially equal to the original length of the material as inserted into the shredding mechanism.

The term “cross cut” as used herein is a broad term and is used in its ordinary sense and is used without limitation to describe apparatus, devices, systems, and the like, that cut material into substantially rectangular pieces having lengths and widths that are generally less than the length and width of the original, unshredded material.

The term “media” as used herein is a broad term and is used in its ordinary sense and is used without limitation to describe generally planar household and office materials capable of being shredded. Such materials include, but are not limited to, paper, paper with fasteners, compact disks, floppy disks, envelopes, credit cards, cardstock, memory cards and the like.

The term “consumer-sized” as used herein is a broad term and is used in its ordinary sense and is used without limitation to describe apparatuses, devices, systems, and the like, that are generally used in a home or office setting. For example, a “consumer-sized shredder” refers to a shredder that is generally used in a home or a small office. For instance, a consumer-sized shredder may generally have a smaller shredding capacity (e.g., 30 sheets) than a larger, commercial-sized or industrial-sized shredder.

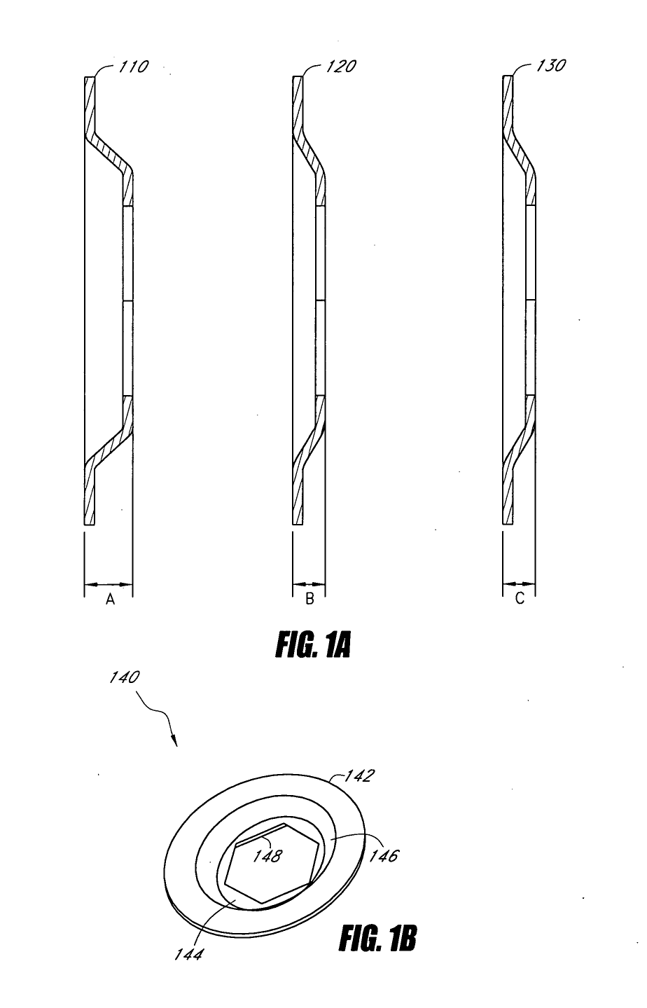

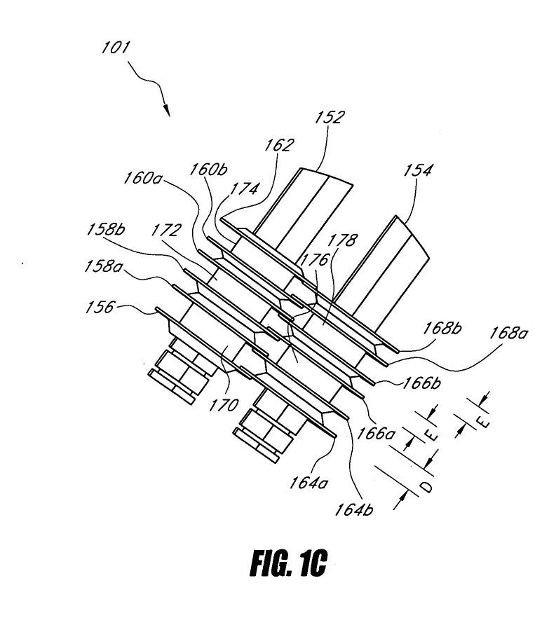

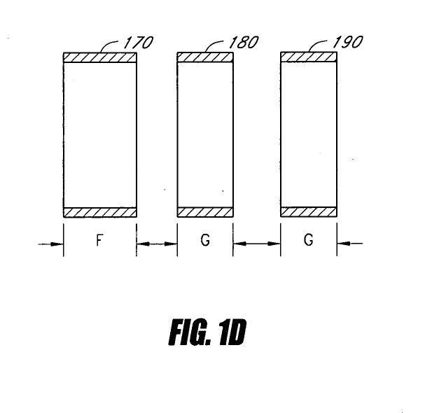

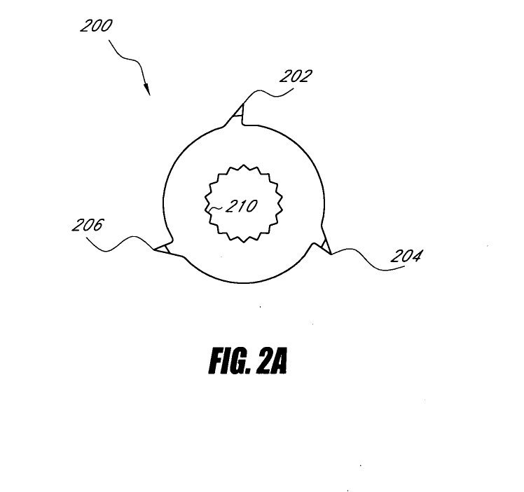

FIG. 1A illustrates a cross-sectional view of a plurality of shredder blades usable with a strip-cut shredder according to certain embodiments of the invention. In particular, a first blade 110, a second blade 120 and a third blade 130 may be used with a strip-cut shredder device capable of cutting material into pieces having different widths and substantially the same length. In certain embodiments, the length of the resulting strips is equal to the length of the original material as it is fed into the shredder.

As shown, the blade 110 has a width “A,” the blade 120 has a width “B” and the blade 130 has a width “C.” In particular, the widths of the blades 120 and 130 are substantially equal; whereas, the width of the blade 110 is greater than the width of blades 120 and 130. In other embodiments, the three blades 110, 120 and 130 may each have a different width, or other pairs of blades may have the same width.

In certain embodiments, the width of the shredder blade determines, at least in part, the width of a shredded piece of material. For example, blades with larger widths will result in a shredded piece of material having a large width. In certain embodiments, blades with smaller widths provide for greater security in that a corresponding shredded material is cut into more (smaller) pieces in comparison to using blades with larger widths.

FIG. 1B illustrates a perspective view of a shredder blade 140 usable with a strip-cut shredder according to certain embodiments of the invention. In particular, the structure of the blade 140 may be used with any of the blades 110, 120, 130 illustrated in FIG. 1A. As shown, the blade 140 includes a circular outer knife edge 142 that is in a substantially parallel plane to a circular inner surface 144. The knife edge 142 is further coupled to the inner surface 144 through a partially conical surface 144. The width of the illustrated blade 140 is determined by the orthogonal distance between the planes of the knife edge 142 and the inner surface 144.

The inner surface 144 further includes an aperture 148 that preferably fits a rotatable member, such as a shredder roller, usable to rotate blades of a shredding device. As shown, the aperture 148 is hexagonally shaped. In yet other embodiments, the aperture 148 may take on other shapes (e.g., circular, polygonal, oval, and the like) to appropriately fit the corresponding shredder roller.

In certain embodiments, the knife edge 142 comprises a metal material capable of cutting material, such as paper. In certain embodiments, the knife edge 142 includes an outer portion (e.g., rim) having a sharpened surface. In certain further embodiments, the outer portion may further include a serrated, or partially serrated, surface.

FIG. 1C shows a partial perspective view of a strip-cut shredding mechanism 150 according to certain embodiments of the invention. In particular, the strip-cut shredding mechanism 150 includes a first roller 152 and a second roller 154 extending in substantially parallel directions. Positioned on the first roller 152 are a first outside blade 156, a first pair of blades 158a, 158b, a second pair of blades 160a, 160b, and a second outside blade 162. Positioned on the second roller 154 are a third pair of blades 164a, 164b, a fourth pair of blades 166a, 166b, and a fifth pair of blades 168a, 168b.

As shown, the blades 156, 158a, 158b, 164a and 164b have substantially the same width. In particular, each of the blades 156, 158a, 158b, 164a and 164b has a width approximately equal to D/2, wherein “D” is equal to an orthogonal distance, or spacing, between the blade edges of adjacent blades, as shown with reference to the third pair of blades 164a, 164b. For instance, in certain embodiments, the blades 156, 158a, 158b, 164a and 164b may have a configuration similar to blade 110 of FIG. 1A (e.g., a larger width). In certain embodiments, “D” is in the range of approximately five to approximately eight millimeters (e.g., 5, 6, 7 or 8 millimeters). In other embodiments, “D” may be equal to a distance less than five millimeters, such as in a range between approximately two and approximately five millimeters (e.g., 2, 3, 4 or 5 millimeters).

The blades 160a, 160b, 162, 164a, 164b, 166a and 166b also have substantially the same width. In particular, each of the blades 160a, 160b, 162, 166a, 166b, 168a and 168b has a width approximately equal to E/2, wherein “E” is equal to the orthogonal distance, or spacing, between the blade edges of certain adjacent blades, as shown with reference to the fourth pair of blades 166a, 166b, and the fifth set of blades 168a, 168b. For instance, in certain embodiments, the blades 160a, 160b, 162, 166a, 166b, 168a and 168b may have a configuration similar to blades 120 and 130 of FIG. 1A (e.g., a smaller width). In certain embodiments, “E” is in the range of approximately two to approximately five millimeters (e.g., 2, 3, 4 or 5 millimeters). In yet other embodiments, “E” is less than two millimeters.

FIG. 1C further illustrates a plurality of spacers (or “ring guards”) positioned between the blades of the shredding mechanism 150. In particular, the shredding mechanism 150 includes a first spacer 170 disposed between blades 156 and 158a, a second spacer 172 disposed between blades 158b and 160a, a third spacer 174 disposed between blades 160b and 162, a fourth spacer 176 disposed between blades 164b and 166a, and a fifth spacer 178 disposed between blades 166b and 168a. In certain embodiments, the width of each spacer depends on the width of the corresponding blade set on the opposing roller. For instance, the width of the first spacer 170 may be determined by the width of the third blade pair 164a, 164b (e.g., width “D”). In certain embodiments, the spacers are substantially cylindrically shaped and include an aperture for fitting on a roller extending therethrough.

As shown, the rollers 152 and 154 are shaped to pass through respective apertures of the corresponding shredder blades. In certain preferred embodiments, the rollers 152 and 154 have a polygonal cross-section (e.g., hexagonal) to prevent slippage of the blades during rotation. As also shown, the blades of a common blade pair are, in certain embodiments, situated on the respective roller such that a first side of the inner surface of one blade contacts a second side of an inner surface of another blade. Furthermore, the outer edge of the blade knife edge contacts, or is in close proximity to, a knife edge of a blade on the opposing roller.

As the rollers 152 and 154 rotate in opposite directions, the shredding mechanism 150 is capable of cutting material, such as media, into strips of different widths. In particular, appropriate material, such as a piece of paper, is fed through an opening in a shredder housing such that an edge of the paper is directed between the rotating rollers 152 and 154. As the paper is fed through the rollers 152, 154, portions of the paper are cut into different sized strips depending on which blades cut the paper. For instance, with reference to FIG. 1C, portions of the paper cut by the third pair of blades 164a, 164b would have a larger width (i.e., width “D”) than portions of the paper being cut by the fourth pair of blades 166a, 166b or the fifth pair of blades 168a, 168b (i.e., width “E”).

Because blades along a shredding roller may have varying widths, certain portions of the shredding roller may result in a higher blade density (higher number of blades per area) than other portions of the shredding roller. Such differing blade densities may be advantageously used to produce shredded media of different sizes and make recombination of the shredded media more difficult.

In yet other embodiments, the shredding mechanism 150 may cut paper into strips having three or more different-sized widths. In such embodiments, the shredding mechanism 150 may include a first set of blades having a first width, a second set of blades having a second width, and a third set of blades having a third width.

FIG. 1D illustrates cross-sectional views of ring guards or spacers usable with embodiments of the invention. In particular, a first spacer 170 has a width “F,” and a second spacer 180 and a third spacer 190 have a width “G,” which is less than width “F.” In certain embodiments, each of the cylindrical spacers 170, 180, 190 may be used to appropriately separate blades in a strip-cut shredder device, such as one usable with the shredding mechanism 150 of FIG. 1C.

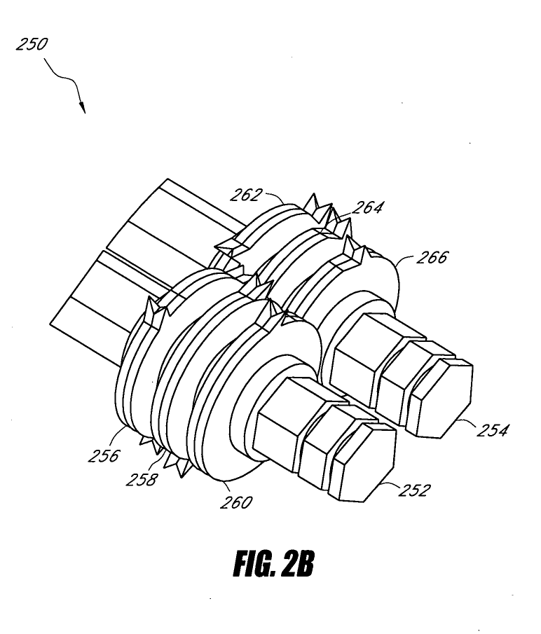

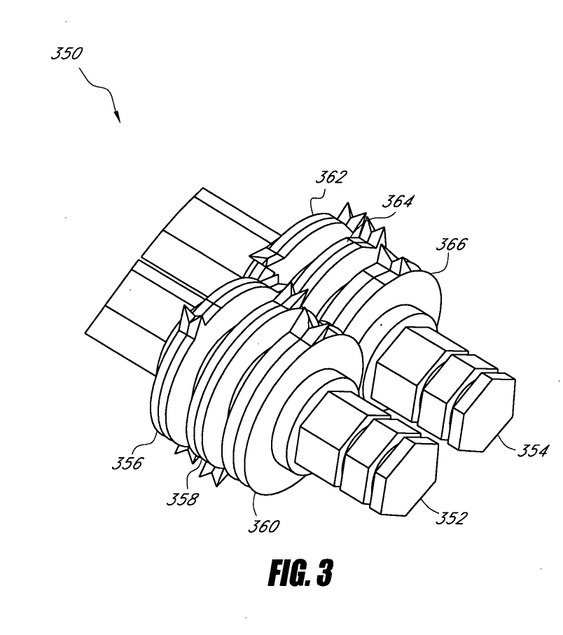

FIG. 2A illustrates a side cross-sectional view of a blade 200 usable with a cross-cut shredder according to certain embodiments of the invention. As shown, the blade 200 is substantially cylindrical and includes a plurality of blade tips disposed around a circumference of the blade for cross-cutting a material into different lengths. In particular, the illustrated blade 200 comprises three blade tips with unequal spacing therebetween. The blade 200 includes a first tip 202 and a second blade tip 204 separated by approximately 80 degrees. A third blade tip 206 is positioned approximately 120 degrees from the second blade tip 204 and approximately 160 degrees from the first blade tip 202.

The blade 200 further includes an aperture 210 for securing a shredder roller extending therethrough. As shown, the aperture 210 has a jagged inner surface for securing an outer surface of the shredder roller. In other embodiments, the inner surface of the aperture 210 may take on a different surface and/or shape (e.g., hexagonal).

In certain embodiments, the outer circumference of the blade 200 is approximately 90 millimeters. In such embodiments, the distance between the first tip 202 and the second tip 204 is approximately 20 millimeters; the distance between the second tip 204 and the third tip 206 is approximately 30 millimeters; and the distance between the third tip 206 and the first tip 204 is approximately 40 millimeters. In such embodiments, material being shredded by the blade 200 is cut into pieces having a set of lengths of approximately 20, 30 and 40 millimeters.

In other embodiments, other positionings of the blade tips may be used around the circumference of the blade 200. For instance, the blade tips may be spaced apart by 90 degrees, 90 degrees and 180 degrees. In yet other embodiments, only two blade tips may be used such the distance between the two tips around one side of the blade is longer than the distance between the two tips around the opposite side of the blade. In yet other embodiments, four or more blade tips may be used and/or spaced as appropriate for cutting material into pieces of multiple sizes.

FIG. 2B illustrates a partial perspective view of a cross-cut shredding mechanism 250 capable of shredding material into pieces of different lengths. In certain embodiments, the shredding mechanism 250 uses one or more blades similar to the blade 200 of FIG. 2A.

As shown, the cross-cut shredding mechanism 250 includes a first roller 252 and a second roller 254 extending in substantially parallel directions. Situated on the first roller 252 is a first set of blades, which includes a first blade 256, a second blade 258, and a third blade 260. Situated on the second roller 254 is a second set of blades, which includes a fourth blade 262, a fifth blade 264 and a sixth blade 266. The first set of blades is positioned such that the blades 256, 258, 260 are spaced apart by blades of the second set. That is, in certain embodiments, a portion of the blade 256 contacts or is in close proximity to a portion of the opposing blades 262 and 264. Likewise, a portion of blade 264 contacts or is in close proximity to a portion of the opposing blades 256 and 258. In certain embodiments, a divider, such as a plastic divider separates opposing blades such that a small gap exists therebetween.

As illustrated, each of the blades of the shredding mechanism 250 includes two substantially similar sections. In particular, the disc-shaped sections are coupled together to form a single blade. In certain embodiments, the circumference of each blade section is between approximately 70 millimeters and approximately 130 millimeters. The width of each blade section, in certain embodiments, may be between approximately one millimeter and approximately four millimeters. Furthermore, the length of the blade tip may be on the order of approximately three millimeters to approximately twelve millimeters.

As illustrated, each of the blades 256, 258, 260, 262, 264, 266 has substantially the same width. In such an embodiment, as a particular material passes, and/or is fed, through the shredder rollers 252, 254, the resulting shredded pieces have substantially the same width. For instance, the width of the shredded medium may correspond to the blade widths (e.g., approximately 4 millimeters).

As also illustrated by FIG. 2B, each of the blades 256, 258, 260, 262, 264, 266 has a plurality of blade tips for creating a cross cut when shredding material.

As described with reference to the blade 200 of FIG. 2A, in certain embodiments, the blade tips on each blade may be spaced apart at different intervals such that the width of the shredded material differs between certain portions. In yet other embodiments, two or more pair of blade tips may have the same spacing therebetween.

For instance, in certain embodiments, one or more of the blades 256, 258, 260, 262, 264, 266 have three blade tips, wherein the spacing between each of the three tips is defined by approximately 80 degrees, approximately 120 degrees and approximately 160 degrees, respectively. In such embodiments, the lengths of shredded portions cut by the blades correspond to the ratio of 2:3:4. For instance, blades having a 90-millimeter circumference cut material into shredded portions having lengths of approximately 20 millimeters, approximately 30 millimeters and approximately 40 millimeters.

In certain embodiments of the invention, the spacing between blade tips may also differ between blades of the shredding mechanism 250. For instance, in certain embodiments, the first set of blades 256, 258, 260 may each have three blade tips spaced apart by 80 degrees, 120 degrees and 160 degrees, respectively, which results in shredded media having a first set of sizes. The second set of blades may each have blade tips spaced apart by different intervals, such as approximately 90 degrees, approximately 90 degrees and 180 degrees, which results in shredded media having a second set of sizes. In yet other embodiments, blades positioned on the same roller may include different blade tip spacings.

It is contemplated that any variety of tip spacings may be used as appropriate with embodiments of the present invention. Furthermore, in certain embodiments, one or more of the blades 256, 258, 260, 262, 264, 266 may have more or less than three blade tips. For instance, some of the blades may include only one blade tip, two blade tips or at least four blade tips. For example, in certain embodiments, the blades may be configured to shred material into any of the combinations of sizes in the table below.

| | Width × | Width × | Width × | Width × |
|---|---|---|---|---|
| | Length | Length | Length | Length |
| | (milli- | (milli- | (milli- | (milli- |
| | meters) | meters) | meters) | meters) |
| Combination #1 | 4 × 40 | 4 × 50 | | |
| Combination #2 | 4 × 30 | 4 × 50 | | |
| Combination #3 | 4 × 30 | 4 × 40 | 4 × 40 | |
| Combination #4 | 4 × 25 | 4 × 35 | 4 × 45 | |
| Combination #5 | 2 × 10 | 2 × 20 | 2 × 30 | 2 × 40 |

Thus, it is appreciated that the shredding mechanism 250 may include blades having varying numbers of blade tips and/or varying spacing between such blade tips to achieve the desired shredding result.

As the rollers 252 and 254 rotate in opposite directions, the shredding mechanism 250 is capable of cutting material into portions of similar widths and differing lengths. In particular, appropriate material, such as a piece of paper, is fed through an opening in a shredder housing such that an edge of the paper is directed between the rotating rollers 252 and 254. As the paper is fed through the rollers 252, 254, different portions of the paper are cut into different-sized pieces depending on the particular blades through which the paper passes. For example, a first set of blades may cut the paper into pieces having a different set of sizes than those pieces cut by a second set of blades.

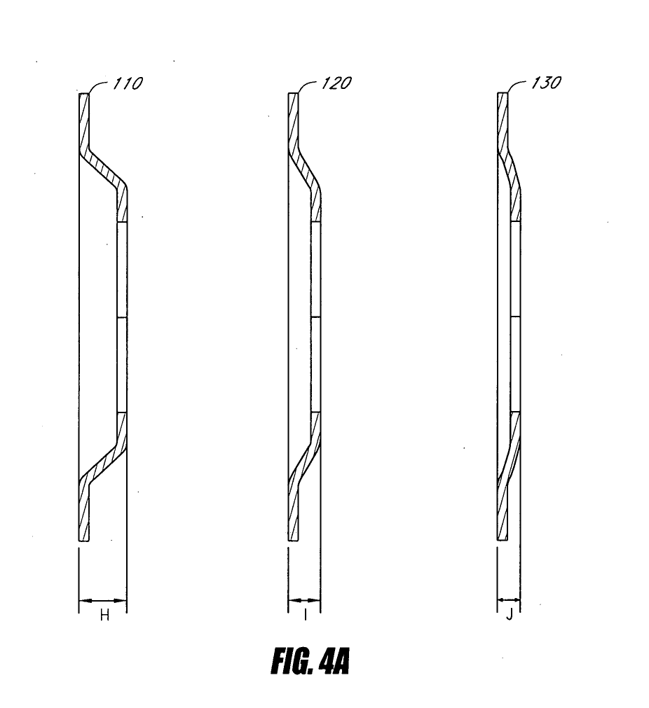

FIG. 3 illustrates a partial perspective view of another embodiment of a cross-cut shredding mechanism 350 using blades of different widths. In particular, the shredding mechanism 350 is structured and operates similarly to the shredding mechanism 250 of FIG. 2B except for the differences detailed below.

As shown, the cross-cut shredding mechanism 350 includes a first roller 352 and a second roller 354 extending in substantially parallel directions. Situated on the first roller 352 is a first set of blades, which includes a first blade 356, a second blade 358, and a third blade 360. Situated on the second roller 354 is a second set of blades, which includes a fourth blade 362, a fifth blade 364 and a sixth blade 366.

As further illustrated, the blades of the shredding mechanism 350 do not have a uniform width. In particular, the blades 360 and 366 are wider than the blades 356, 358, 362 and 364. That is, the blades 360 and 366 result in a set with a higher blade density than set of blades 356, 358, 362 and 364. In such a configuration, the shredding mechanism 350 is capable of shredding material into different widths, based on the widths of the corresponding blades, and different lengths, based on the blade tip spacing. Such a configuration advantageously increases the complexity in, and time required with, reassembling shredded media, such as a document.

As the rollers 352 and 354 rotate in opposite directions, the shredding mechanism 350 is capable of cutting material into strips of different widths and different lengths. In particular, appropriate material, such as a piece of paper, is fed through an opening in a shredder housing such that an edge of the paper is directed between the rotating rollers 352 and 354. As the paper is fed through the rollers 352, 354, different portions of the paper are cut into different sized pieces depending upon which blade or blades cut the particular portion of the paper. For instance, with reference to FIG. 3, portions of the paper cut by the blades 360 and 366 have a larger width than portions of the paper cut by the blades 356, 358, 362, 364.

As will be appreciated, a variety of alternative configurations may be used with the shredding mechanism 350. For instance, the widths of blades on the first roller 352 may be substantially the same but may differ from the widths of blades on the second roller 354. In yet other embodiments, opposing blades may have the same width. In yet other embodiments, the blade tip spacing of the shredding mechanism 350 may be substantially the same for each of the blades, while the widths of the blades may differ.

Furthermore, features of embodiments of the invention disclosed herein may be advantageously used to increase security and privacy in the shredding of certain documents. For instance, in certain embodiments, a shredder may include a configuration of blades that is adapted to shred the center portions of a document into more (i.e., smaller) pieces than the edge portions of documents. In yet other embodiments, the shredder blades may be selectively movable along the shredder roller to customize the widths of the resulting shredded portions.

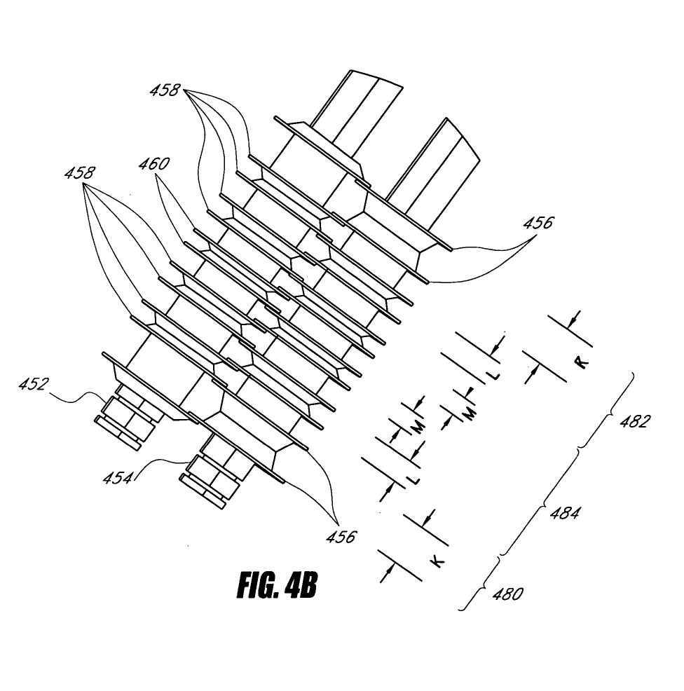

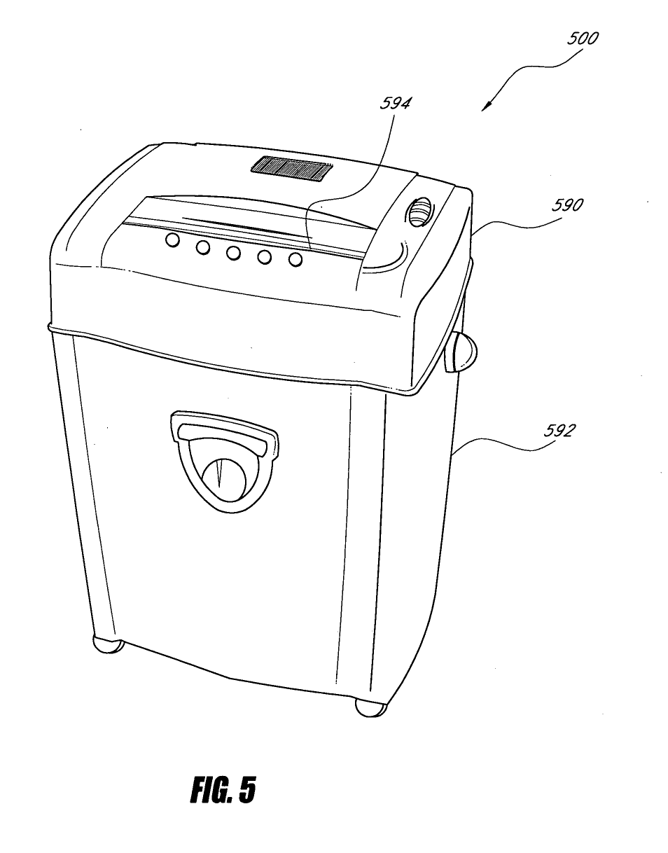

For example, FIG. 4A illustrates a cross-sectional view of three blades usable with a strip-cut shredder according to certain embodiments of the invention. In particular, a first blade 410 of width “H”, a second blade 420 of width “I” and a third blade 430 of width “J” may be used with a shredder device capable of cutting material into pieces having different widths. As shown, the width of blade 410 is greater than the widths of blades 420 and 430, and the width of blade 420 is greater than the width of blade 430. In certain embodiments, blades of only two different widths may be used. In yet other embodiments, blades of more than three different widths may be used.

FIG. 4B illustrates a partial perspective view of a strip-cut shredding mechanism usable with the blades of FIG. 4A. In particular, the strip-cut shredding mechanism is designed to cut a piece of media into pieces having different widths. As shown, a plurality of shredder blades is mounted on a first roller 452 and a second roller 454 such that a portion of blades on opposite rollers overlap.

During the shredding process, one or more pieces of media (e.g., paper) are inserted between the rollers 452, 454 at approximately the location where the blades overlap (e.g., a shredding axis). In certain embodiments, the rollers 452, 454 rotate in opposite directions so as to cut the media passing therethrough. In the depicted embodiment, blades of three widths are positioned along rollers 452, 454: first blades 456, second blades 458, and third blades 460.

As shown, the first blades 456 have the largest spacing (“K”) therebetween and are mounted on outer portions 480 (e.g., ends) of the roller 454. Such a relatively large spacing results in lower blade density and shredded pieces having a relatively large width. The third blades 460 have the smallest spacing (“M”) therebetween and are mounted toward a middle portion 484 of the first and second rollers 452, 454. Such a relatively small spacing results in a higher blade density and shredded pieces having a relatively small width. The second blades 458 have widths (“L”) greater than the widths of the first blades 456 but smaller than the widths of the third blades 460. In certain embodiments, the second blades 458 are located along the rollers 452, 454 between the first blades 456 and the second blades 460.

When one or more pieces of media are inserted into the shredding device of FIG. 4B, the outer portions of the media are cut into wider strips than the middle portion of the media. Shredding media in this way can further protect confidential material. For example, material printed on paper typically has the most information in the middle portion of a page and less text on the outer portions of the page due to margins and other formatting. Consequently, the middle portion of the media may require denser shredding that the outer portions.

In certain embodiments, blades of only two different widths may be used, with the narrowest blades in the center of the page. Additionally, other embodiments may have blades of more than three widths arranged such that the blades with the narrower widths are closer to the middle portion of the roller assembly. In yet other embodiments, the different-width blades may be randomly disposed and/or adjustable along the shredding rollers.

In yet other embodiments, each blade on the shredding device of FIG. 4B has blade tips disposed around the circumference of the blade. The blade tips are used for cross-cutting the media into lengths shorter than the original length of the media. In some embodiments, the cross-cut configuration may cut pieces of multiple lengths. In other embodiments, the blades in the middle portion of the roller assembly have more blade tips than those located at the outer portions of the roller assembly.

Features and advantages of the embodiments of the invention disclosed herein may be used with a wide variety of shredder and shredder blade configurations. For example, FIG. 5 illustrates an exemplary embodiment of a shredder 500 usable with embodiments of the invention. As illustrated, the shredder 500 advantageously comprises a consumer-sized shredding device. In particular, the shredder 500 comprises a shredder body 590 that is configured to house one or more shredder blades, a motor, control circuitry, combinations of the same and the like.

The shredder body 590 is configured to mount on a top of a waste receptacle 592 or other like container for collecting shredded material. The illustrated shredder body 590 additionally comprises a feed opening 594, or inlet portion, to allow the input of material into the shredding device 500. In other embodiments of the invention, the shredder 500 may include structure and/or devices for the automatic feeding of paper into the feed opening 594. For example, the feed opening 594 may be coupled to or be part of a feed tray with feed rollers that advance paper and/or other material into the feed opening 594.

In yet other embodiments, the shredder may incorporate a design or structure similar to the paper shredding devices described in U.S. Pat. No. 6,390,397, issued May 21, 2002 to Joseph Y. Ko, and U.S. patent application Ser. No. 11/227,994, filed Sep. 15, 2005, published as U.S. Patent Publication No. 2006-0054727, the entirety of each of which is hereby incorporated herein by reference and is to be considered a part of this specification. In certain embodiments of the invention, the shredder may comprise a stand-alone shredder that does not require an external receptacle.

In certain embodiments, knife blades having a diagonal or diamond configuration may include varying spacing and/or may comprise a plurality of blade tips having varied spacing for cutting material into different sized portions. Examples of shredders and knife blades for use with the teachings of the present invention are disclosed in U.S. Pat. No. 5,975,445, which is hereby incorporated herein by reference in its entirety and is to be considered a part of this specification.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A consumer-sized shredding device for cutting media into different-sized pieces, the consumer-sized shredding device comprising:
a first rotatable member configured to rotate about a first axis;
a second rotatable member configured to rotate about a second axis substantially parallel to said first axis;
a first plurality of blades disposed along said first rotatable member; and
a second plurality of blades disposed along said second rotatable member, each of said first and second plurality of blades configured to cut a piece of media passing between said first and second rotatable members during rotation of said first and second rotatable members, wherein said second plurality of blades further comprises:
a first blade,
a second blade adjacent said first blade and separated from said first blade along said second axis by a first spacing, and
a third blade adjacent said second blade and separated from said second blade along said second axis by a second spacing larger than said first spacing.

2. The consumer-sized shredding device of claim 1, wherein at least one blade of said first and second plurality of blades comprises at least two blade tips non-uniformly disposed around a periphery of the at least one blade.

3. The consumer-sized shredding device of claim 2, wherein said at least one blade further comprises at least three blade tips, wherein the distance between a first blade tip and a second blade tip is different than the distance between the second blade tip and a third blade tip.

4. The consumer-sized shredding device of claim 3, wherein said second blade tip is positioned approximately 120 degrees from said first blade tip, and wherein said third blade tip is positioned approximately 180 degrees from said second blade tip.

5. The consumer-sized shredding device of claim 3, wherein said second blade tip is positioned approximately 120 degrees from said first blade tip, and wherein said third blade tip is positioned approximately 160 degrees from said second blade tip.

6. The consumer-sized shredding device of claim 1, wherein said second plurality of blades further comprises a fourth blade adjacent said third blade and separated from said third blade along said second axis by a third spacing different than each of said first and second spacings.

7. The consumer-sized shredding device of claim 6, wherein said third spacing is larger than said second spacing.

8. The consumer-sized shredding device of claim 1, wherein said first spacing is between approximately two millimeters and approximately five millimeters.

9. The consumer-sized shredding device of claim 1, wherein said second spacing is between approximately five millimeters and approximately eight millimeters.

10. The consumer-sized shredding device of claim 1, wherein a circumference of each of said first and second plurality of blades is between approximately 70 millimeters and approximately 130 millimeters.

11. A household shredding device for cutting media into different-sized portions, the household shredding device comprising:
a first rotatable member having a distal end, a proximal end and a middle portion therebetween, said first rotatable member configured to rotate about a first axis;
a second rotatable member having a distal end, a proximal end and a middle portion therebetween, said second rotatable member configured to rotate about a second axis substantially parallel to said first axis;
a plurality of blades disposed along said first and second rotatable members, said plurality of blades configured to shred a piece of media passing between said first and second rotatable members during rotation of said first and second rotatable members, wherein a first portion of the plurality of blades is positioned with a first density along the middle portions of the first and second rotatable portions, and wherein a second portion of the plurality of blades is positioned with a second density near the distal and proximal ends of the first and second rotatable portions, said first density being different than said second density.

12. The household shredding device of claim 11, wherein each of said plurality of blades comprises at least one blade tip disposed around a periphery of each of said plurality of blades.

13. The household shredding device of claim 12, wherein each blade of said first portion of the plurality of blades comprises more blade tips than each blade of said second portion of the plurality of blades.

14. A method for shredding media into portions of different sizes, the method comprising:
receiving a piece of media through a feed opening of a consumer-sized shredding device with a first rotatable member and a second rotatable member each having a plurality of blades attached thereto;
rotating said first and second rotatable members such that the plurality of blades engages the piece of media along a shredding axis as the piece of media passes between said first rotatable member and said second rotatable member;
cutting a first portion of the piece of media at a first location along said shredding axis to produce shredded media having a first set of sizes; and
cutting a second portion of the piece of media at a second location along said shredding axis to produce shredded media having a second set of sizes different from said first set of sizes.

15. The method of claim 14, wherein each of said plurality of blades comprises a plurality of blade tips disposed along a periphery of each blade.

16. The method of claim 15, wherein the blade tips of at least one of the plurality of blades are non-equally spaced.

17. The method of claim 15, wherein a first blade of the plurality of blades comprises a different number of blade tips that a second blade of the plurality of blades.

18. The method of claim 17, wherein said first blade is located proximate said first location and said second blade is located proximate said second location.

19. A consumer-sized shredding device comprising:
means for accepting a piece of media inserted into the shredding device;
means for cutting the piece of media into first shredded portions having a first set of sizes; and
means for cutting the piece of media into second shredded portions having a second set of sizes that differs from said first set of sizes.

20. The consumer-sized shredding device of claim 19, wherein the first set of sizes of said first shredded portions comprises different widths than the second set of sizes of said second shredded portions.

21. The consumer-sized shredding device of claim 19, wherein the first set of sizes of said first shredded portions comprises different lengths than the second set of sizes of said second shredded portions.
